(19) United States
(12) Patent Application Publication
(10) Pub. No.: US 2021/0198286 A1
(43) Pub. Date: Jul. 1, 2021

(54) Method of preparing metal complexes of formula Z-M, in particular carbene-metal complexes

(71) Applicant: Universiteit Gent, Gent (BE)

(72) Inventor: Catherine Suzanne Julienne Cazin, Zwijnaarde (BE)

(73) Assignee: Universiteit Gent, Gent (BE)

(21) Appl. No.: 17/272,666

(22) PCT Filed: Sep. 2, 2019
(86) PCT No.: PCT/EP2019/073358

§ 371 Date: Mar. 2, 2021

(30) Foreign Application Priority Data
Sep. 3, 2018 (EP) 18192247.7

(51) Int. Cl. C07F 1/08; C07F 15/00; C07F 1/10; B01J 31/22

(52) U.S. Cl. CPC C07F 1/08; C07F 15/006; C07F 1/10; C07F 15/0073; B01J 2531/822; B01J 2531/16; B01J 2531/17; B01J 2531/18; B01J 2531/824; B01J 31/2273

(57) ABSTRACT

The present invention relates to an improved method of preparing metal complexes, in particular carbene-metal complexes. The method comprises the step of subjecting a salt of formula Z⁺—X⁻ and a non-ionic metal salt of formula MLₙ or subjecting a metallate of formula Z⁺ . . . MLₙX⁻ to a mechanical mixing process in the presence of a base. The method allows to formation of heterocyclic carbene metal complexes such as a nitrogen-containing heterocyclic carbene (NHC)-metal complexes. The invention also relates to the use of metal complexes, in particular carbene-metal complexes such as heterocyclic carbene-metal complexes obtainable by the method according to the present invention as catalysts.

### FIELD OF THE INVENTION

The present invention relates to an improved method of preparing metal complexes of formula Z-M, in particular carbene-metal complexes. Preferred carbene-metal complexes obtainable by such a method comprise heterocyclic carbene-metal complexes such as nitrogen-containing heterocyclic carbene (NHC)-metal complexes of formula Z-M. The invention also relates to the use of metal complexes, in particular carbene-metal complexes such as heterocyclic carbene-metal complexes obtainable by such method as catalysts.

### BACKGROUND ART

The last few decade heterocyclic carbene-metal complexes and in particular nitrogen-containing heterocyclic carbene (NHC)-metal complexes have gained considerable interest. They have been investigated as catalyst for polymerization reactions, cyclization reactions, cross-coupling reactions, etc. Additionally, heterocyclic carbene-metal complexes have gained attention in other areas, as for example in biological materials and medicinal chemistry.

The most common synthetic strategy to prepare heterocyclic carbene-metal complexes and in particular nitrogen-containing heterocyclic carbene (NHC)-metal complexes is based on the reaction of a free carbene with a metal source. Such a method has some important drawbacks. The method is highly sensitive to moisture and oxygen and thus requires working in an inert atmosphere and under strictly anhydrous conditions. Furthermore, the method requires the use of a strong base and requires cooling. Consequently, the method is expensive and has a high negative impact on the environment.

More recently, improved procedures using a carbene precursor (for example an imidazolium salt) and a metal source to form a metallate that is able to form carbene complexes in the presence of a mild base and a solvent have been reported. Although the impact on the environment has been reduced by such improved procedure, access to a general synthetic route leading to NHC-metal complexes under mild, user- and environment-friendly conditions remain highly desirable.

It is well known that the use of solvents has disastrous environmental impact. While intense work has been carried out to develop greener alternatives, the greenest option remains solventless. Mechanochemistry can provide solventless alternatives. Although the technique is well established for organic synthesis, the use of mechanochemistry for the synthesis of organometallic compounds is still underexplored.

### SUMMARY OF THE INVENTION

It is an object of the present invention to provide an environmentally friendly, solvent-free method of preparing metal complexes of formula Z-M, in particular carbene-metal complexes such as heterocyclic carbene-metal complexes.

It is another object of the present invention to provide a method of preparing metal complexes of formula Z-M, in particular carbene-metal complexes, such as heterocyclic carbene metal complexes, giving high yields.

It is a further object of the present invention to provide a method of preparing metal complexes of formula Z-M, in particular carbene-metal complexes, such as heterocyclic carbene metal complexes without the need of using free carbenes.

Furthermore it is an object of the present invention to provide a method of preparing metal complexes of formula Z-M, in particular carbene-metal complexes, such as heterocyclic carbene metal complexes, having drastically shorted reaction times compared to prior art methods.

Additionally, it is an object of the present invention to provide a method of preparing metal complexes of formula Z-M, in particular carbene-metal complexes, such as heterocyclic carbene-metal complexes that is generally applicable across the Periodic Table.

According to a first aspect of the present invention, a method of preparing a metal complex of formula Z-M, the method comprising the steps of
i1) providing a salt of formula Z⁺—X⁻ and a non-ionic metal salt of formula MLₙ; or
i2) providing a metallate of formula Z+ . . . MLnk_{;}
   with
   Z comprising a two-electron donor ligand;
   X comprising an anion;
   M comprising a metal, and preferably a transition metal;
   L comprising an anion or an electron donor ligand, for example a one-electron donor ligand or a two-electron donor ligand;
   and
ii) subjecting the salt of formula Z⁺—X⁻ and the metal salt of formula MLₙ of step i1) or the metallate of formula Z⁺-M-Lₙ-X⁻ of step i2) to a mechanical mixing process in the presence of a base to form said metal complex of formula Z-M.

The metal complex of formula Z-M may comprise a single two-electron donor ligand Z, i.e. exactly one two-electron donor ligand Z. The Z ligand can be mono- or multidentate in nature. Alternatively, the metal complex of formula Z-M may comprise multiple two-electron donor ligands Z, for example multiple two-electron donor ligands Z that are identical or multiple donor ligands Z that are not or not all identical, for example a combination of electron donor ligands Z1 and electron donor ligands Z2.

A preferred group of metal complexes that can be prepared by the method according to the present invention comprises metal complexes of formula Z-M comprising a single electron donor ligand, for example comprising a carbene as two-electron donor ligand Z. Other preferred metal complexes of formula Z-M comprise a carbene as two-electron donor ligand Z1 and a halide as a one- or three electron donor ligand Z2.

The base used in step ii) can be added before the mechanical mixing process of step ii), as for example at step) or step i2), after step) or step i2) or during the mechanical mixing process of step ii). Alternatively, part of the base is added before the mechanical mixing process of step ii), for example at step) or step i2) or after step) or step i2) while part of the base is added during the mechanical mixing process.

Compared to methods known in the art, the method according to the present invention has the advantage that no use of solvents is required.

Furthermore the method according to the present invention has the advantage that the method allows easy scaling up.

A first preferred method according to the present invention comprises the reaction of a salt of formula Z⁺—X⁻ with a non-ionic metal salt of formula MLₙ according to the following reaction:

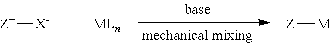

For the purpose of this invention a non-ionic metal salt of formula MLₙ includes all salts that are not ionic salts. Ionic salts refer to salts of formula M^{x+}Lₙ^{y-} whereby the metal and the anion are bonded by an ionic bond. Preferred non-ionic metal salts used in the method according to the present invention comprise compounds whereby the metal M and the anion L are bonded by a covalent or dative bond. It is clear that the non-ionic salts used in the method according to the present invention comprise electronically neutral compounds.

Preferred non-ionic metal salts of formula MLₙ used in the method according to the present invention are salts comprising a single metal M. Examples comprise CuCl, AgCl, AuCl, PdCl₂, NiCl₂, [RhLₙCl]₂,[IrLnCl]₂, Ru(arene)Cl₂]₂.

Preferably, the salt of formula Z⁺—X⁻ comprises a single two-electron donor ligand Z, i.e. exactly one single two-electron donor ligand. A preferred example of a salt of formula Z⁺—X⁻ comprises a single carbene ligand.

The first preferred method according to the present invention does not require the presence of an ionic metal salt, in particular the presence of an ionic transition metal salt. Furthermore the first step of the first preferred method according to the present invention does not require an anion methathesis. Anion methathesis involves the simple exchange of anions between two anion-cation bearing compounds. The first step of the first preferred method according to the present invention preferably requires an addition of the non-ionic metal salt ML₂ to the anion X⁻ of the salt of formula Z⁺—X⁻ to form the metallate of formula Z⁺ . . . MLₙX⁻.

A second preferred method according to the present invention comprises the reaction of a metallate of formula Z⁺-M-Lₙ-X⁻ according to the following reaction:

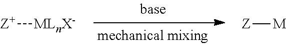

The metallate of formula Z⁺ . . . MLₙX⁻ comprises preferably a single two-electron donor ligand Z, i.e. exactly one two-electron donor ligand. A preferred example of a metallate of formula Z⁺, . . . MLₙX⁻ comprises a single carbene ligand precursor.

The metallate of formula Z⁺ . . . MLₙX⁻ can be obtained by any known method. A preferred method to obtain the metallate of formula Z⁺ . . . MLₙX⁻ is by a mechanical mixing process starting from a salt of formula Z⁺—X⁻ and a metal salt of formula MLₙ, preferably a non-ionic metal salt and/or a metal salt comprising a single metal M, according to the following reaction:

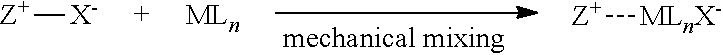

The mechanical mixing process may comprise any mechanical mixing process known in the art.

Preferred mechanical mixing processes comprise milling, grinding or a combination of milling and grinding. The mechanical mixing process comprises for example ball milling using for example steel, stainless steel, metal oxide, for example zirconium oxide, ceramic or rubber balls. Alternatively the mechanical mixing process comprises hand grinding using a mortar and pestle.

The two-electron donor ligand Z may for example be a carbene, a phosphorus donor ligand, a nitrogen donor ligand or any other heteroatom donor ligand. Preferably, the two-electron donor ligand Z comprises a carbene.

Preferred phosphorus donor ligands comprise phosphines, phosphites, phosphonites and phosphinites. Preferred nitrogen donor ligands comprise amines and imines.

A carbene ligand may be acyclic or cyclic. Cyclic carbene ligands comprise for example a ring of from 4 to 9 members. Preferred cyclic carbene ligands comprise a ring of 5 members or 6 members and most preferably a ring of 5 members.

The carbene ligands, either cyclic or acyclic, may comprise one or more heteroatom(s). The heteroatom preferably comprises N, O, B, P or S. In case the carbene ligands comprise more than one heteroatom, the heteroatoms may be the same or may be different.

For example the carbene ligand may be selected from the following group of mono carbenes or polycarbenes:

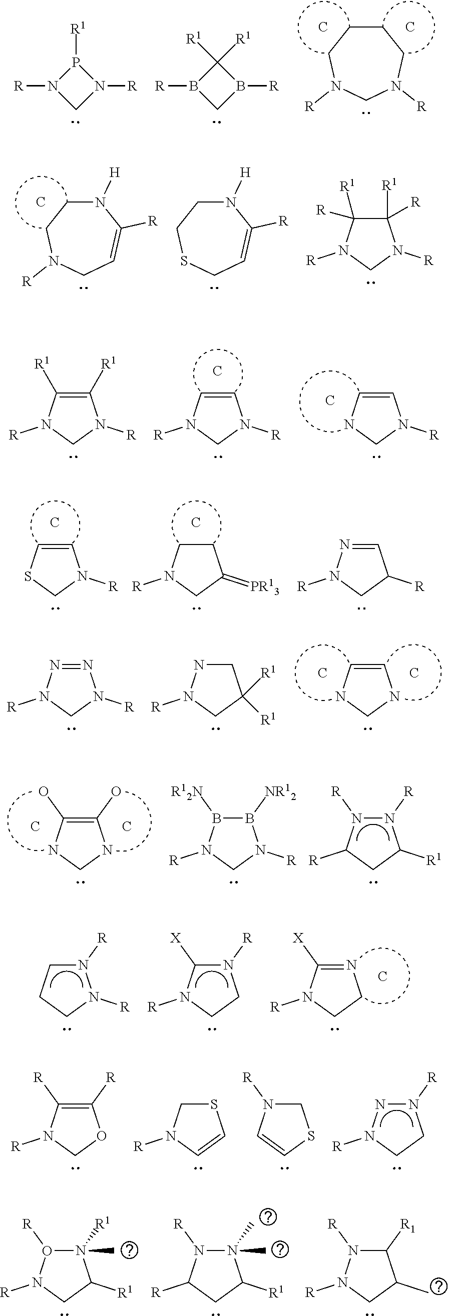

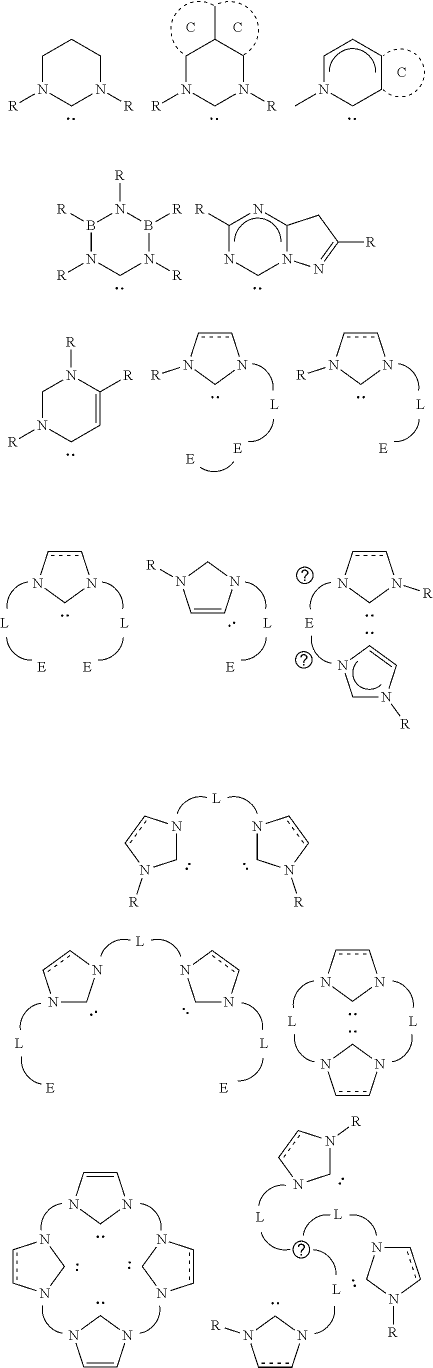

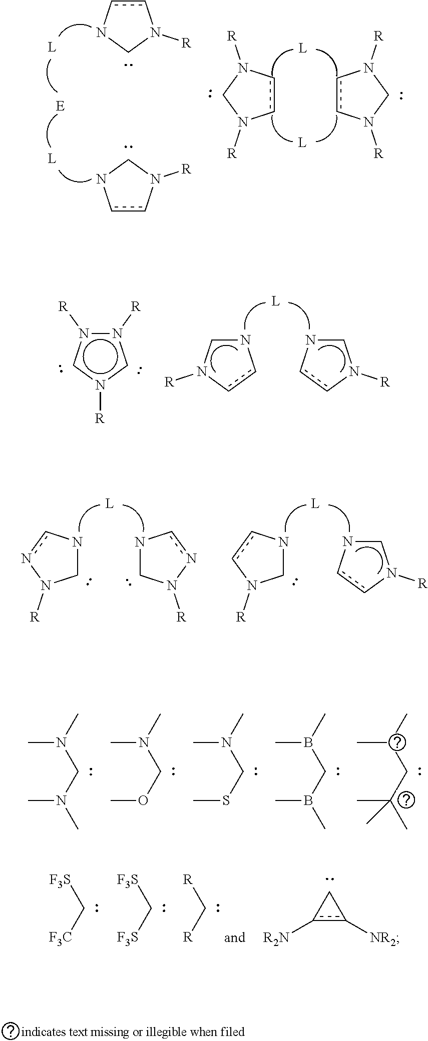

wherein

each R and R¹ may be, independently for each occurrence, selected from: hydrogen, a primary, secondary or tertiary alkyl group (for example C1-C18 or C1-C14) that may be substituted or unsubstituted and may be cyclic, substituted or unsubstituted aryl (for example substituted or unsubstituted phenyl, naphthyl or anthracenyl), substituted or unsubstituted heterocycle, for example pyridine, or a functional group selected from the group consisting of halideo, hydroxyl, alkoxyl, aryloxyl, sulfhydryl, cyano, cyanato, thiocyanato, amino, nitro, nitroso, sulfo, sulfonato, boryl, borono, phosphono, phosphonato, phosphinato, phospho, phosphino, and siloxy; each E is a substituent that may coordinate to a (transition) metal and may be independently for each occurrence, a primary, secondary or tertiary alkyl group (for example C1-C18 or C1-C14) that may be substituted or unsubstituted and may be cyclic, substituted or unsubstituted aryl (for example substituted or unsubstituted phenyl, naphthyl or anthracenyl), substituted or unsubstituted heterocycle, for example pyridine, or a functional group selected from the group consisting of halide, hydroxyl, alkoxyl, sulfhydryl, cyano, cyanato, thiocyanato, amino, nitro, nitroso, sulfo, sulfonato, boryl, borono, phosphono, phosphonato, phosphinato, phospho, phosphino, and siloxy;

each L is a linker group that may be a covalent bond or an alkanediyl group (for example C1-C18 or C1-C14) that may be substituted or unsubstituted heterocycle (for example pyridyl);

[symbol] represents an optional fused ring or rings, for example having from 4 to 7 carbons that may be saturated or unsaturated and may include heteroatoms such as O, P, S or N; and a dashed line represents optional unsaturation.

The groups E, R and R¹ may be, independently for each occurrence, unsaturated alkyl i.e. alkenyl (for example C2-C18 or C2-C14), that may be substituted or unsubstituted and may be cyclic.

Preferred carbene ligands are heterocyclic carbene ligands, having a ring of 4 to 7 members, and more preferably having a ring of 5 or 6 members. The ring may be saturated or unsaturated and may comprise one or more heteroatoms (such as O, B, P and S) in the ring.

Preferred heterocyclic carbene ligands comprise nitrogen-containing heterocyclic carbene ligands (NHC) having a ring of 4 to 8 members, for example 4 to 7 members. More preferably, the NHC has a ring of 5 or 6 members. The NHC may be saturated or unsaturated and may contain one or more nitrogen atoms. Optionally, the NHC may comprise other heteroatoms (such as O, B, P and S) in the ring.

The NHC ligands have for example the form of formula (I):

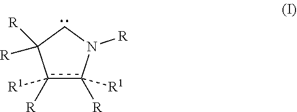

wherein
the groups R may be the same or different,
the groups R¹ may be the same or different; and
the dashed line in the ring represents optional unsaturation (R¹ and R² are absent in case of unsaturation).

One or more of the carbon atoms in the ring (apart from the carbene carbon) may be substituted with a heteroatom, for example O, B, P or S.

Each of the groups R and R¹ may be independently for each occurrence, selected from: H, a primary or secondary alkyl group that may be unsaturated and may be substituted or unsubstituted and may be cyclic, substituted or unsubstituted aryl, a substituted or unsubstituted heterocycle, or a functional group selected from the group consisting of halide, hydroxyl, sulfhydryl, cyano, cyanato, thiocyanate, amino, nitro, nitroso, sulfa, sulfonato, boryl, borono, phosphono, phosphinato, phosphinato, phospho, phosphino and siloxy.

The groups R and R1 may be, independently for each occurrence unsaturated alkyl i.e. alkenyl (for example C2-C18 or C2-C14), that may be substituted or unsubstituted and may be cyclic.

Advantageously, NHC ligands bearing two nitrogen atoms in the ring, each adjacent the carbene carbon may be employed. The NHC ligands of this type may be of the form according to formula II:

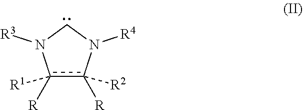

wherein
each of the groups R, R¹, R², R³ and R⁴ may be the same or different; and
the dashed line in the ring represents optional unsaturation (R¹ and R² are absent in case of unsaturation).

One or more of the carbon atoms in the ring (apart from the carbene carbon) may be substituted with a hetetoratom, for example O, B, P or S.

Each of the groups R, R¹, R², R³ and R⁴ may be independently for each occurrence selected from: hydrogen, a primary, secondary or tertiary alkyl group (for example C1-C18 or C1-C14) that may be unsaturated and may be substituted or unsubstituted and may be cyclic, substituted or unsubstituted aryl (for example substituted phenyl, naphthyl or anthracenyl), a substituted or unsubstituted heterocycle (for example pyridine), or a functional group selected from the group consisting of halide, hydroxyl, alkoxyl, aryloxyl, sulfhydryl, cyano, cyanate, thicyanato, amino, nitro, nitroso, sulfo, sulfonate, boryl, borono, phosphonato, phosphinato, phospho, phosphino and siloxy.

Advantageously, the groups R³ and R⁴ may be substituted or unsubstitued aromatic rings that may be heterocyclic aromatic rings.

Substituents R, R¹, R², R³ and R⁴ of structures of formula (II) may include alkyl and unsaturated alkyl groups, aryl groups that may be substituted and may contain heteroatoms.

Suitable examples of NHC carbene ligands include those according to formulae A-F:

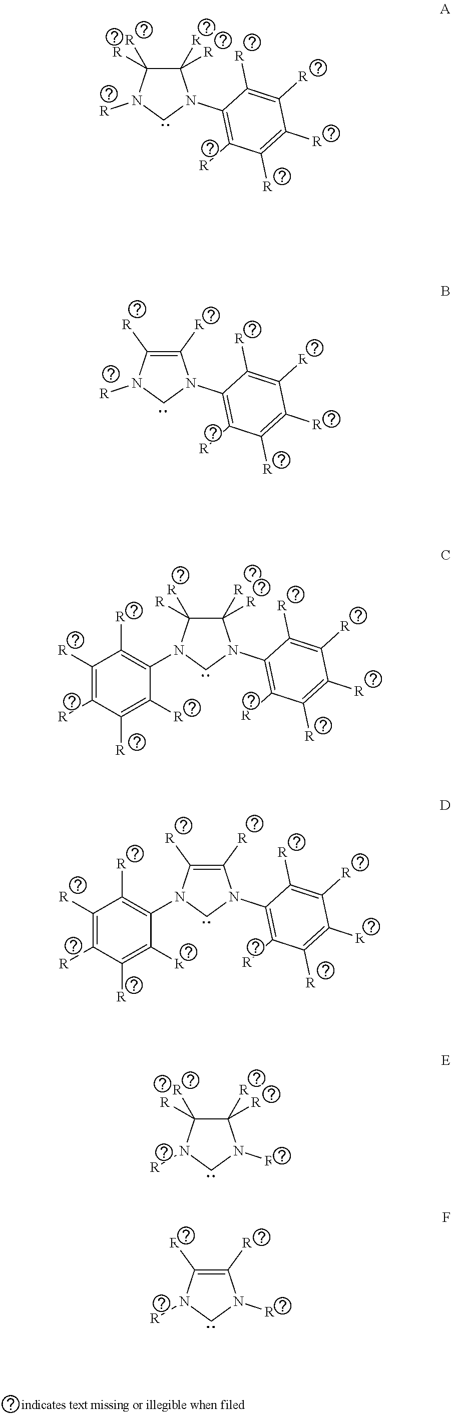

wherein
each group R⁵, R⁶, R⁷, is independently for each occurrence selected from: hydrogen, a primary, secondary or tertiary alkyl group (for example C1-C18 or C1-C14) that may be substituted or unsubstituted and may be cyclic, substituted or unsubstituted aryl (for example substituted or unsubstituted phenyl, naphthyl or anthracenyl), substituted or unsubstituted heterocycle, for example pyridine, or a functional group selected from the group consisting of halide, hydroxyl, aryloxyl, sulfhydryl, cyano, cyanato, thiocyanato, amino, nitro, nitroso, sulfo, sulfonate, boryl, borono, phosphino, phosphonato, phosphinato, phosphor, phosphino, and siloxy; R⁸, R⁹, R¹⁰ and R¹¹ are each independently for each occurrence selected from: hydrogen, a substituted or unsubstituted alkyl group (for example C1-C10 or C1-C4), a halide, alkoxide, hydroxide, substituted or unsubstituted aryl, or in formulae B and D together with the carbons carrying them form a substituted or unsubstituted, fused 4-8 membered carbocyclic ring or a substituted or unsubstituted, fused aromatic ring, preferably a fused phenyl ring; and R¹² is alkyl (for example C1-C18 or C1-C14) or a cycloalkyl (for example C3-C12).

For the avoidance of doubt where two R⁵ groups, for example, may be present, such groups may be different.

Particularly preferred NHC ligands comprise carbenes according to the following formulae:

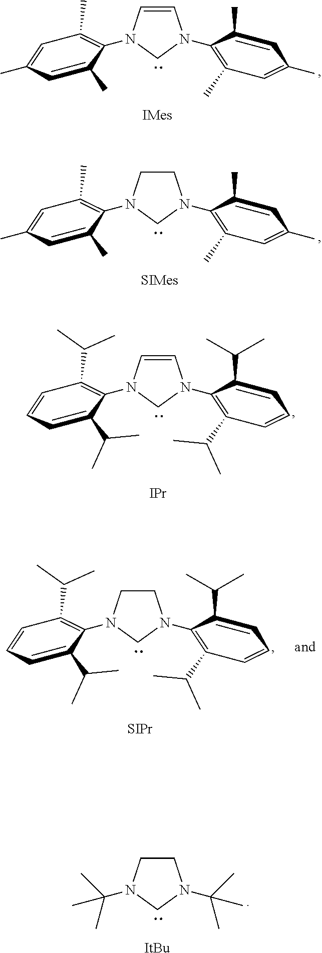

As mentioned above X comprises an anion. For the purpose of this invention the term anion includes any type of negatively charged ions including anionic ligands. Preferably, X is selected from the group consisting of halides, carboxylates, alkoxy groups, aryloxy groups, alkylsulfonates, acetates, trifluoroacetates, tetrafluoroborates, hexafluorophosphates, hexafluoroantimonates, cyanides, thiocyanates, isothiocyanates, cyanates, isocyanates, azides and selenocyanates.

M comprises a metal and preferably a transition metal. Preferred transition metals comprise copper, iron, nickel, manganese, ruthenium, osmium, chromium, cobalt, silver, gold, palladium, platinum, iridium and rhodium.

L comprises an anion or an electron donor ligand, for example a one-electron donor ligand or a two-electron donor ligand. Preferably, L comprises an anion selected from the group consisting of fluoride (F⁻), chloride (Cl), bromide (Br), iodide (I⁻), triflate (trifluoromethane sulfonate) (OTf⁻), acetate (OAc⁻), trifluoroacetate (TFA⁻), tetrafluoroborate (BF₄⁻), hexafluorophosphate (PF₆⁻), hexafluoroantimonate (SbF₆⁻), sulfate (SO₄²⁻) and phosphate (PO₃²⁻).

In case L comprises an electron donor ligand, a two-electron donor ligand is preferred. Examples of two-electron donor ligand comprise a carbene, a phosphorus donor ligand, a nitrogen donor ligand or any other heteroatom donor ligand. Preferred examples of two-electron donor ligands comprise the above-described ligands Z.

As mechanical mixing process any process using physicochemical and/or chemical transformations induced by mechanical forces can be considered.

Preferred mechanical mixing processes comprise milling, grinding or a combination of milling and grinding. The mechanical mixing process comprises for example ball milling using for example steel, stainless steel, metal oxide, ceramic or rubber balls. Alternatively, the mechanical mixing process comprises hand grinding for example using a mortar and pestle.

Other preferred mechanical mixing processes comprise screw extrusion as for example twin-screw extrusion.

The base present in step ii) of the method according to the present invention may comprise any base, either a strong or a mild base.

The method according to the present invention allows preparation of metal complexes, in particular carbene-containing complexes such as heterocyclic carbene complexes using a mild base without requiring a strong base. This is considered as an important advantage compared to methods known in the art.

Preferred bases comprise for example a mild base selected from the group consisting of carbonates as for example K₂CO₃, hydrogen carbonates, phosphates and amines.

Counter-intuitively, the metal complex of formula Z-M can be prepared according to the method of the present invention using a base having a basicity lower than is needed to deprotonate the salt of formula Z⁺—X⁻ and/or the metallate of formula Z⁺, . . . MLₙX⁻.

According to a second aspect of the present invention, the use of a carbene-metal complex obtainable from the above-described method, in particular a heterocyclic carbene-metal complex, as catalyst is provided. Preferably, the use of a carbene-metal complex, in particular a heterocyclic carbene-metal comprise as catalyst is provided under solventless or neat conditions.

The carbene-metal complexes and in particular the heterocyclic carbene-metal complexes are in particular suitable to be used in palladium-cross coupling, ruthenium-based olefin metathesis, gold mediated transformations including additions and cyclizations, copper mediated borylation and C—H functionalization.

### BRIEF DESCRIPTION OF THE DRAWINGS

The present invention will be discussed in more detail below, with reference to the attached drawings, in which:

FIG. 1 to FIG. 17 show ¹H NMR spectra of different metallates and metal complexes.

FIG. 18 shows the chemical structure of some N-heterocyclic carbene precursor ligand salts.

### DESCRIPTION OF EMBODIMENTS

The present invention will be described with respect to particular embodiments and with reference to certain drawings but the invention is not limited thereto but only by the claims.

All reactions were carried out in a planetary mill.

The following abbreviations are used in the examples
IPr.HCl: 1,3-bis(2,6-diisopropylphenyl)-1H-imidazol-3-ium chloride
SIPr.HCl: 1,3-bis(2,6-diisopropylphenyl)-1H-imidazol-3-ium chloride
IMes.HCl: 1,3-dimesityl-1H-imidazol-3-ium chloride
SIMes.HCl: 1,3-dimesityl-4,5-dihydro-1H-imidazol-3-ium chloride
IPr*.HCl: 1,3-bis(2,6-dibenzhydryl-4-methylphenyl)-1H-imidazol-3-ium chloride
IAd.HCl: 1,3-di((3S,5S,7S)-adamantan-1-yl)-1H-imidazol-3-ium chloride
ICy.HCl: 1,3-dicyclohexyl-1H-imidazol-3-ium chloride
ItBu.HCl: 1,3-di-tert-butyl-1H-imidazol-3-ium chloride
MIC A.HCl: 4-(4-(tert-butyl)phenyl)-1-(2,6-diisopropylphenyl)-3-methyl-1H-1,2,3-triazol-3-ium chloride MIC B.HCl: 1-benzyl-4-(4-(tert-butyl)phenyl)-3-methyl-1H-1,2,3-triazol-3-ium chloride
CAAC^{Me2}.HCl: 1-(2,6-diisopropylphenyl)-2,2,4,4-tetramethyl-3,4-dihydro-2H-pyrrol-1-ium chloride
CAAC^{Cy}.HCl: 2-(2,6-diisopropylphenyl)-3,3-dimethyl-2-azaspiro[4.5]dec-1-en-2-ium chloride:

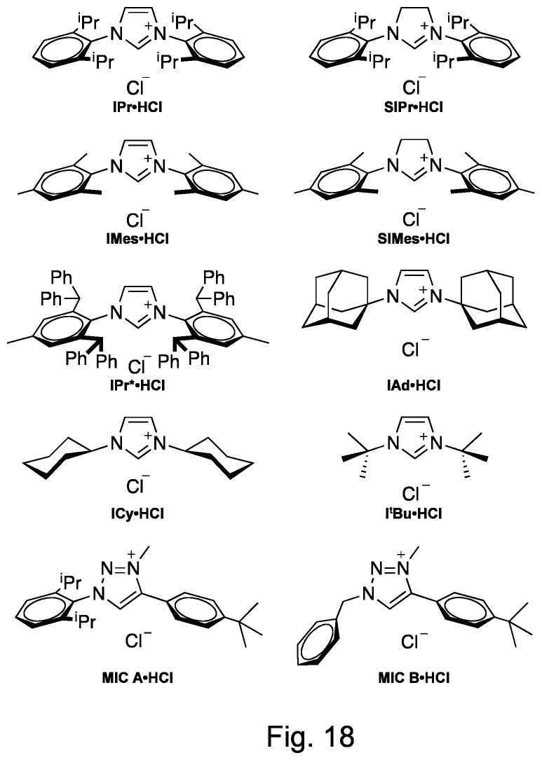

The chemical structure of a number of the above mentioned N-heterocyclic carbene ligand salts are shown in FIG. 18.

### Example 1: Synthesis of [IPrH][CuCl₂] Metallate

A milling jar was charged with IPrHCl (4 g), CuCl and milling balls. The jar was placed in the planetary mill. The mixture was ground by ball milling.

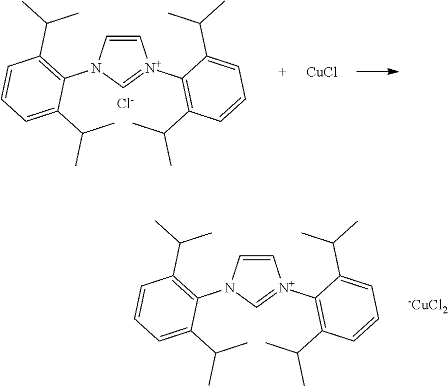

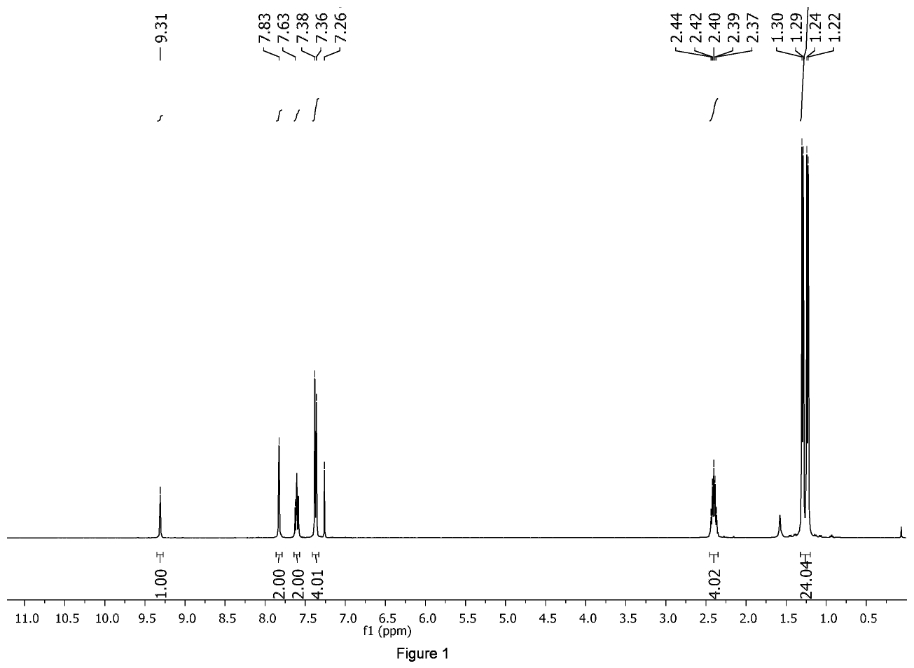

In a vial a powder was recovered from the bowl. A ¹H NMR spectrum was recorded to confirm product formation. The ¹H NMR spectrum is given in FIG. 1.

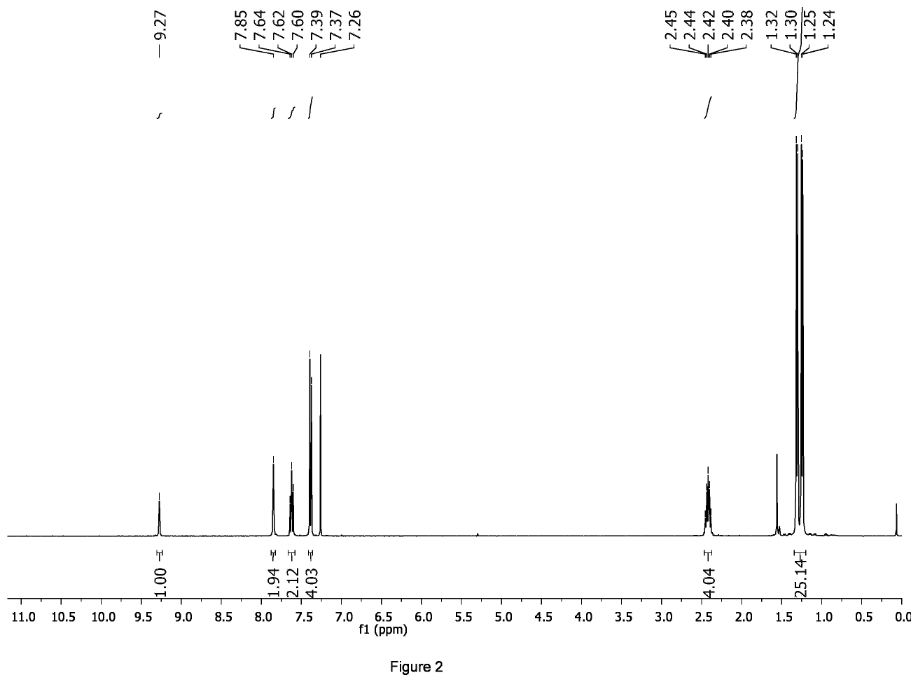

A microcrystalline solid product was isolated. The ¹H NMR spectrum of the product is given in FIG. 2.

The total yield of the obtained powder is 97%.

The analyses of the ¹H NMR spectra of FIG. 1 and FIG. 2 are given below: ¹H NMR (400 MHz, CDCl₃) δ (ppm) 9.31 (s, H_{NCHN}, 1H), 7.83 (s, H_{CH═CH}, 2H), 7.63 (t, p-H_{Ar}, 2H), 7.38 (d, m-H_{Ar}, 4H), 2.44 (m, CH(iPr), 4H), 1.30 (d, (CH₃)₂, 12H), 1.24 (d, (CH₃)₂, 12H) (FIG. 1); ¹H NMR (400 MHz, CDCl₃) δ (ppm) 9.27 (s, H_{NCHN}, 1H), 7.85 (s, H_{CH═CH}, 2H), 7.64 (t, p-H_{Ar}, 2H), 7.39 (d, m-H_{Ar}, 4H), 2.47 (m, CH(iPr), 4H), 1.32 (d, (CH₃)₂, 12H), 1.25 (d, (CH₃)₂, 12H) (FIG. 2).

### Example 2: Synthesis of [SIPrH][CuCl₂] Metallate

SIPr.HCl (2 g) and CuCl were ground by ball milling.

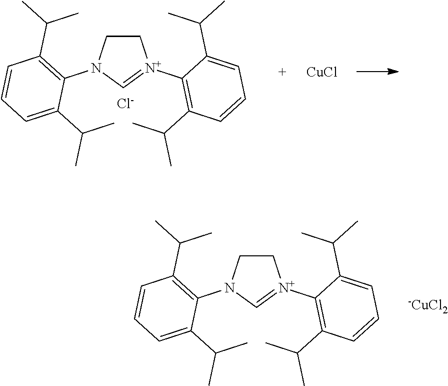

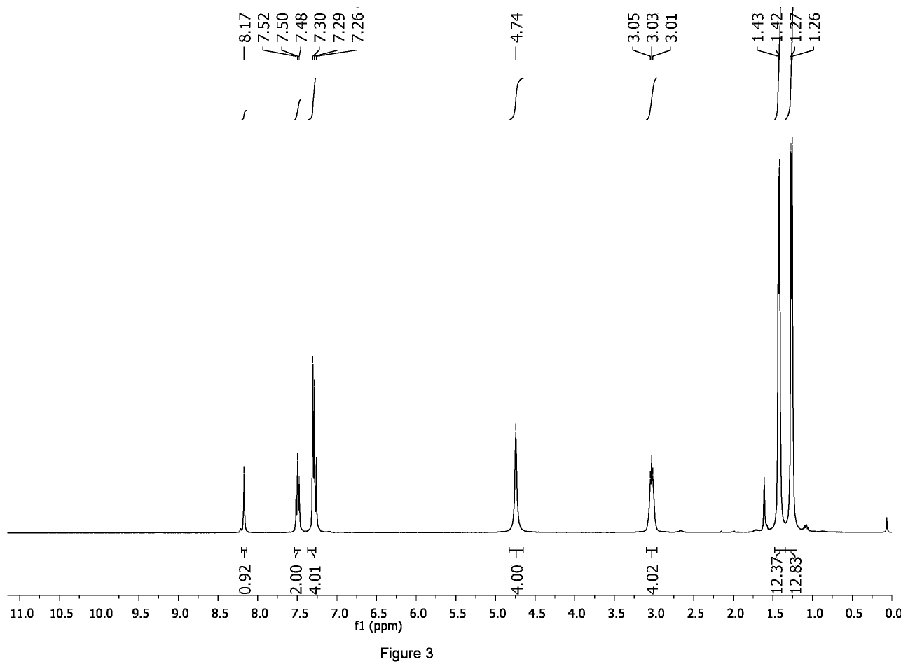

The powder was recovered from the reactor. The ¹H NMR spectrum of the powder is given in FIG. 3.

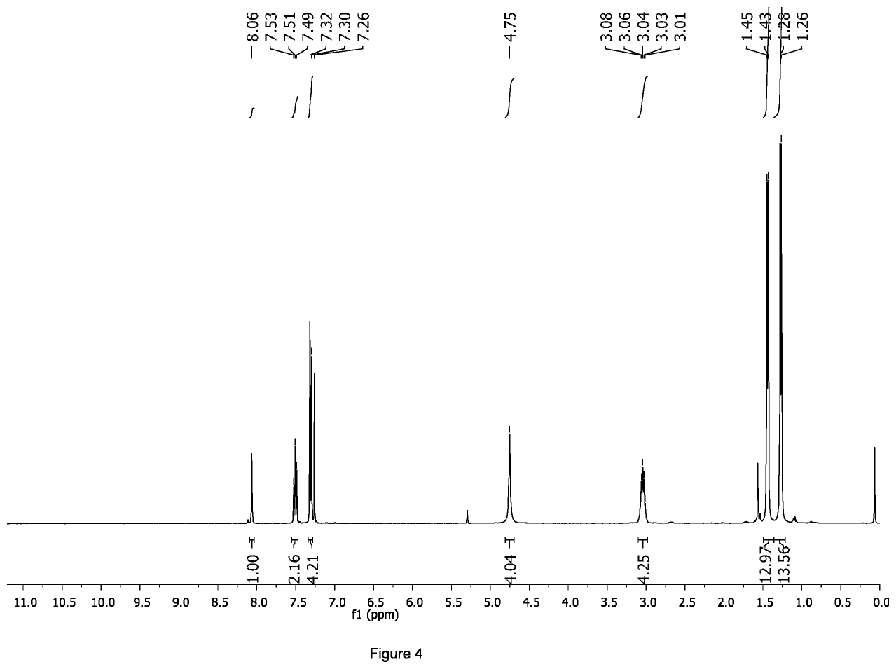

The solid content in the marbles as well as the remaining solid present in the reactor and on the lid was recovered. The ¹H NMR spectrum is given in FIG. 4.

The total yield of the obtained powder is 97%.

The analyses of the ¹H NMR spectra of FIG. 3 and FIG. 4 are given below:

¹H NMR (400 MHz, CDCl₃) δ (ppm) 8.11 (s, H_{NCHN}, 1H), 7.45 (t, p-H_{Ar}, 2H), 7.24 (d, m-H_{Ar}, 4H), 4.68 (s, H_{CH—CH}, 4H), 2.98 (m, CH(iPr), 4H), 1.37 (d, (CH₃)₂, 12H), 1.21 (d, (CH₃)₂, 12H) (FIG. 3); ¹H NMR (400 MHz, CDCl₃) δ (ppm) 8.06 (s, H_{NCHN}, 1H), 7.53 (t, p-H_{Ar}, 2H), 7.32 (d, m-H_{Ar}, 4H), 4.75 (s, H_{CH—CH}, 4H), 3.08 (m, CH(iPr), 4H), 1.45 (d, (CH₃)₂, 12H), 1.28 (d, (CH₃)₂, 12H) (FIG. 4).

### Example 3: Synthesis of [IPrH][CuCl₃] Metallate

IPrHCl and CuCl₂ were ground by ball milling.

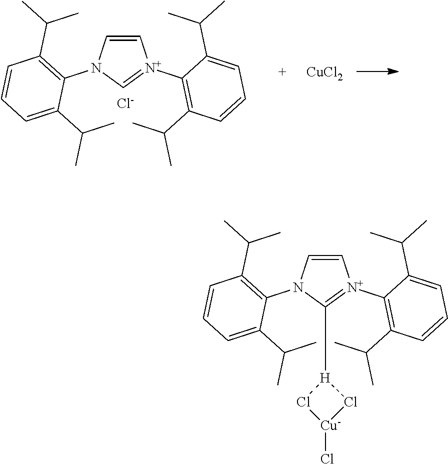

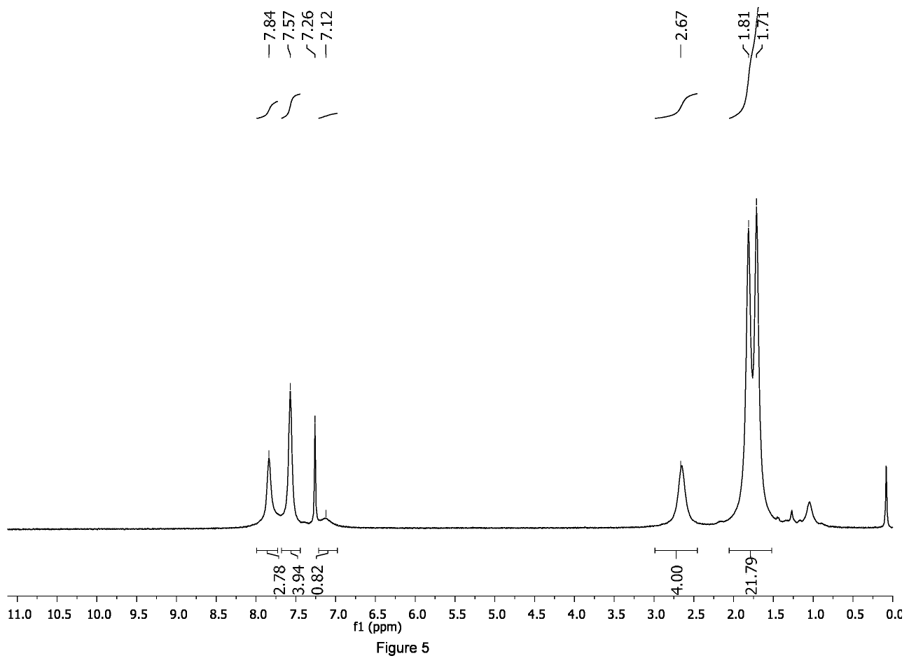

The powder was recovered from the reactor. The ¹H NMR spectrum of the powder is given in FIG. 5.

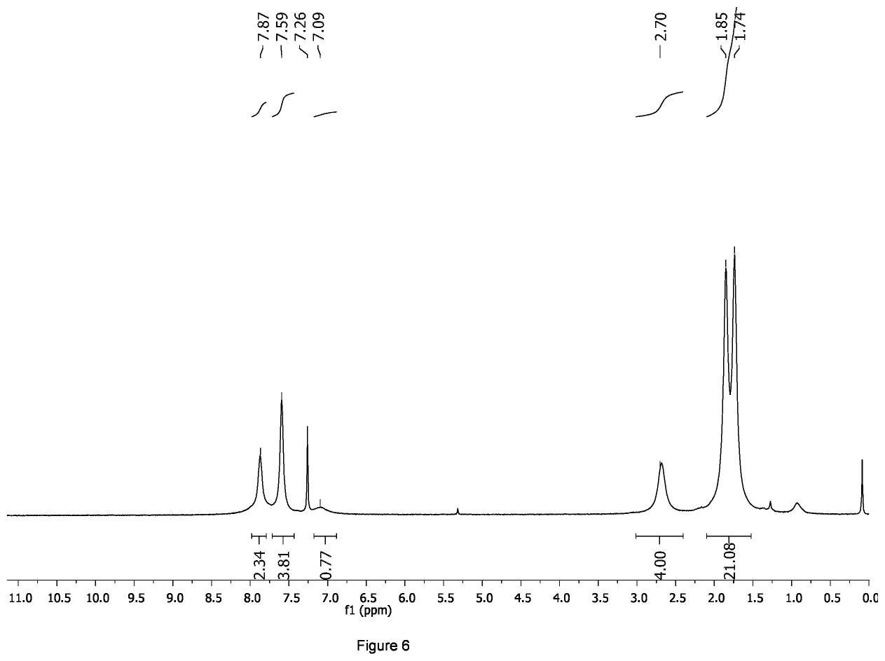

The solid content in the marbles as well as the remaining solid present in the reactor and on the lid was recovered. The ¹H NMR spectrum is given in FIG. 6.

The product was obtained as powder in 99% yield.

The analyses of the ¹H NMR spectra of FIG. 5 and FIG. 6 are given below:

¹H NMR (400 MHz, CDCl₃) δ (ppm) 7.84 (m, p-H_{Ar}, 2H), 7.57 (m, m-H_{Ar}, 4H), 7.12 (m, H_{NCHN}, 1H), 2.67 (m, CH(iPr), 4H), 1.81 (m, (CH₃)₂, 12H), 1.71 (m, (CH₃)₂, 12H) (FIG. 5); ¹H NMR (400 MHz, CDCl₃) δ (ppm) 7.84 (m, p-H_{Ar}, 2H), 7.57 (m, m-H_{Ar}, 4H), 7.09 (m, H_{NCHN}, 1H), 2.70 (m, CH(iPr), 4H), 1.85 (m, (CH₃)₂, 12H), 1.74 (m, (CH₃)₂, 12H) (FIG. 6).

### Example 4: Synthesis of [IPrH][PdCl₃] Metallate

[IPrH][PdCl₃] metallate was synthesized on a small scale (example 4a) and on a large scale (example 4b).

### Example 4a: Small Scale Synthesis of [IPrH][PdCl₃] Metallate

IPr.HCl (0.5 g) and PdCl₂ were ground by ball milling.

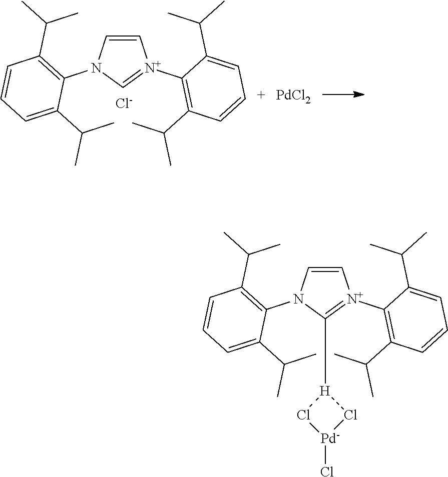

133 mg powder was recovered from the reactor. A further 0.5 g of product was isolated.

The total yield of the obtained powder is 97% yield.

### Example 4b: Large Scale Synthesis of [IPrH][PdCl₃] Metallate

IPr.HCl (1 g) and PdCl₂ were ground using ball milling.

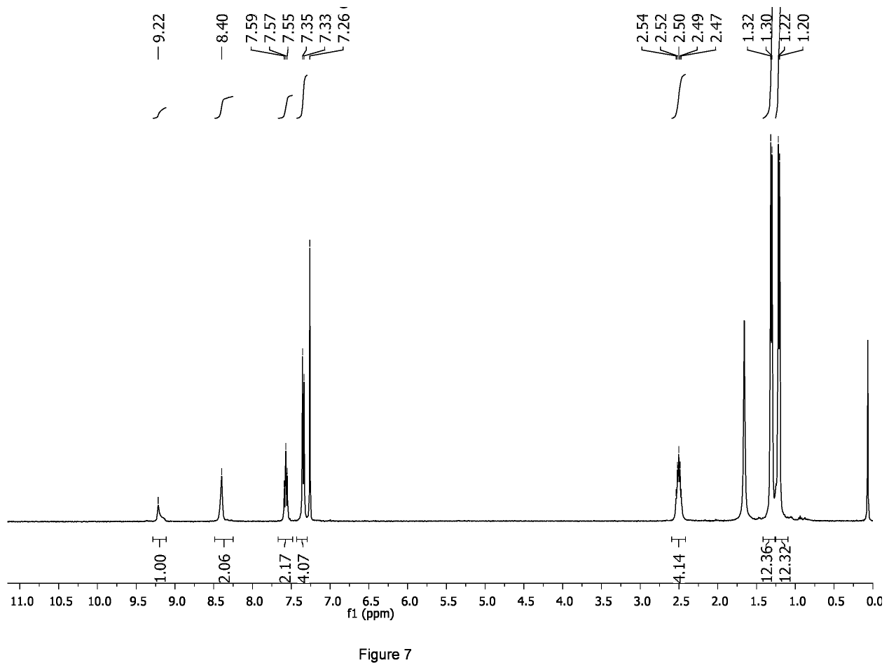

The product was obtained as powder in 99% (1.4 g) yield. The ¹H NMR spectrum is given in FIG. 7.

The analysis of the ¹H NMR spectrum of FIG. 7 is given below:

¹H NMR (400 MHz, CDCl₃) δ (ppm) 9.22 (s, H_{NCHN}, 1H), 8.40 (s, H_{CH═CH}, 2H), 7.59 (t, p-H_{Ar}, 2H), 7.35 (d, m-H_{Ar}, 4H), 2.54 (m, CH(iPr), 4H), 1.32 (d, (CH₃)₂, 12H), 1.22 (d, (CH₃)₂, 12H).

### Example 5: Synthesis of [Pd(IPr)(η³-cin)Cl] Complex

A milling jar was charged with [IPrH][Pd(η³-cin)Cl₂], K₂CO₃ and milling balls. The mixture was ground by ball milling.

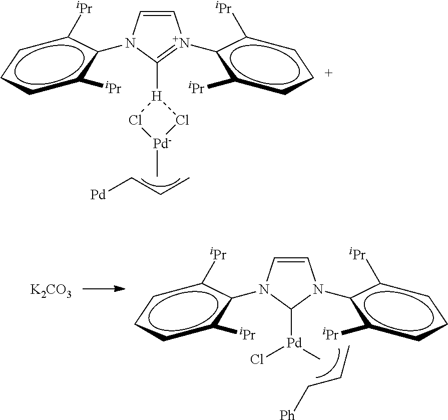

A ¹H NMR spectrum was recorded to confirm the obtained complex.

The powder content from the lid, the reactor bowl and the balls was recovered. The solid was washed.

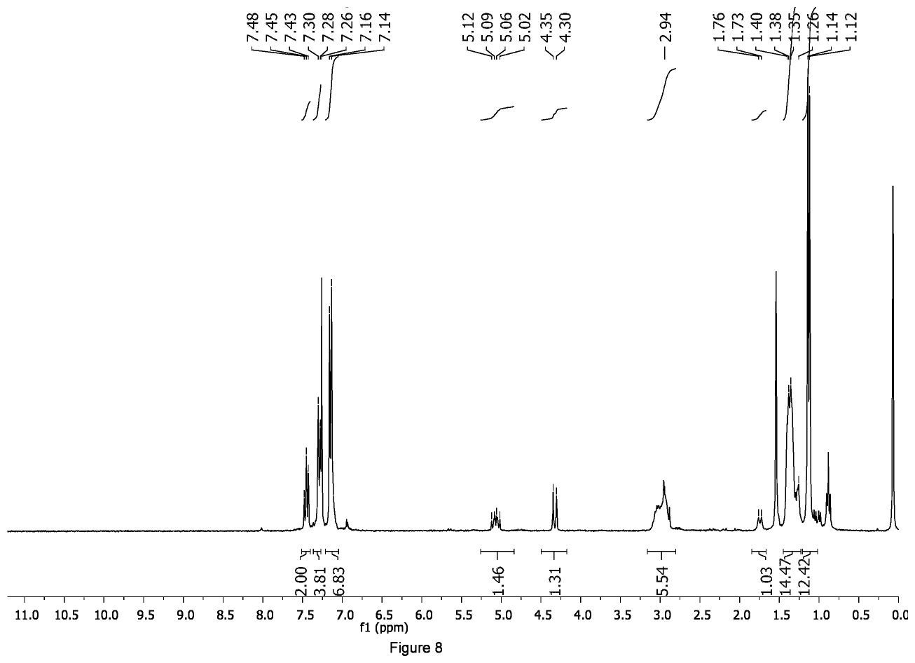

The product was obtained as powder in 87% yield. The ¹H NMR spectrum is given in FIG. 8.

The analysis of the ¹H NMR spectrum of FIG. 8 is given below:

¹H NMR (400 MHz, CDCl₃) δ (ppm) 7.48 (t, H_{CH═CH}, 2H), 7.30 (d, m-H_{Ar}, 4H), 7.16 (d, H_{Ar}, 7H), 5.12 (m, H_{cin}, 1H), 4.35 (d, H_{cin} 1H), 2.94 (m, CH(iPr), 4H), 1.76 (d, H_{cin}, 1H), 1.40 (d, (CH₃)₂, 12H), 1.14 (d, (CH₃)₂, 12H).

### Example 6: Synthesis of [Pd(IPr)(η³-cin)Cl] Complex

[IPrH][Pd(η³-cin)Cl₂] and K₂CO₃ were ground by ball milling.

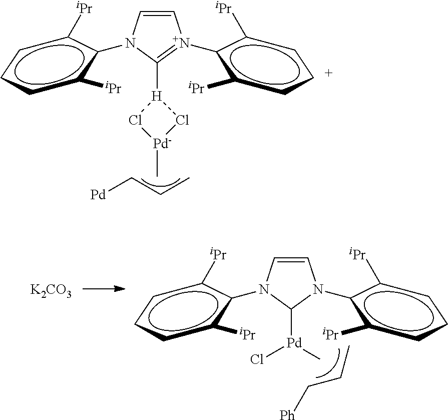

A ¹H NMR was recorded to confirm product formation.

The powder content on the lid, from the reactor bowl and the balls was recovered.

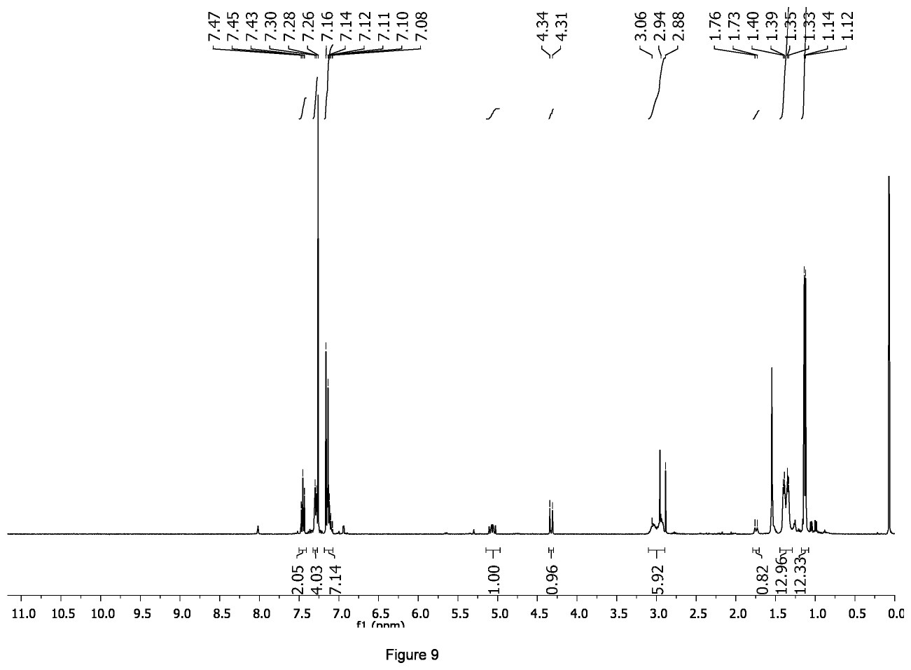

The product was obtained as a microcrystalline powder in 93% yield. The ¹H NMR spectrum is given in FIG. 9.

The analysis of the ¹H NMR spectrum of FIG. 9 is given below:

¹H NMR (400 MHz, CDCl₃) δ (ppm) 7.48 (t, H_{CH═CH}, 2H), 7.30 (d, m-H_{Ar}, 4H), 7.16 (d, H_{Ar}, 7H), 5.12 (m, H_{cin}, 1H), 4.35 (d, H_{cin} 1H), 2.94 (m, CH(iPr), 4H), 1.76 (d, H_{cin}, 1H), 1.40 (d, (CH₃)₂, 12H), 1.14 (d, (CH₃)₂, 12H).

### Example 7: Synthesis of [Pd(SIPr)(η³-Cin)Cl] Complex

A milling jar was charged with SIPr.HCl, [Pd(η³-cin)(μ-Cl)]₂ and milling balls. The jar was then placed in a planetary mill. The mixture was ground by ball milling.

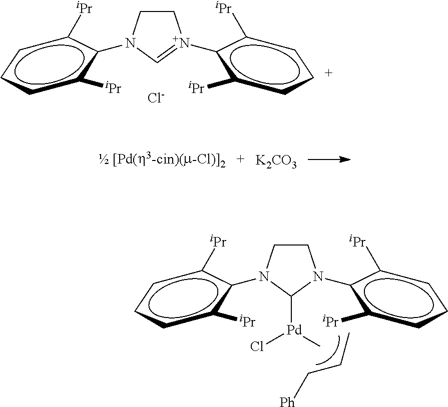

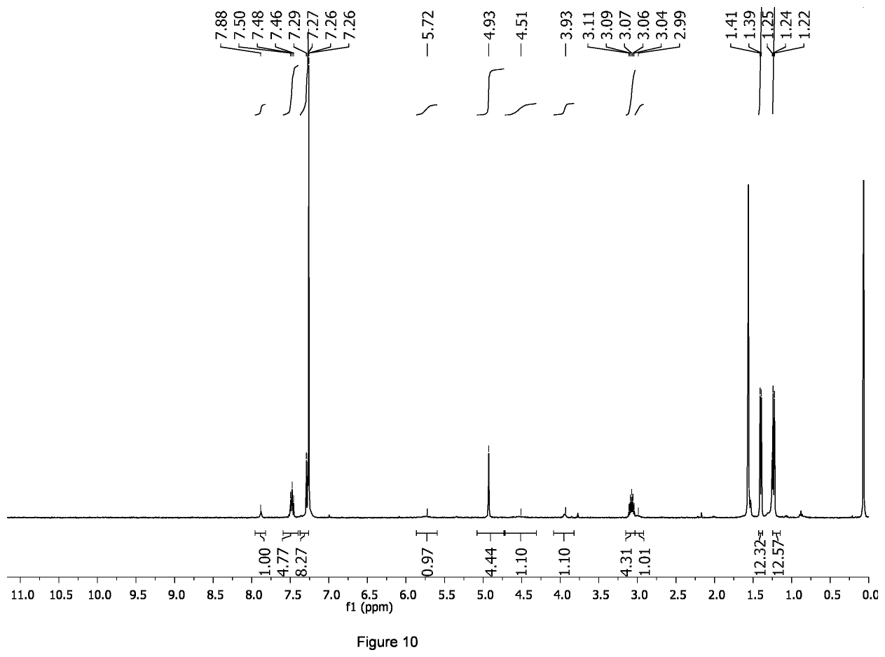

A ¹H NMR spectrum was recorded which confirmed palladate formation (FIG. 10)

Then, K₂CO₃ was added to the reactor and the reaction mixture was ground by ball milling. A ¹H NMR spectrum recorded on a sample after this procedure confirmed product formation.

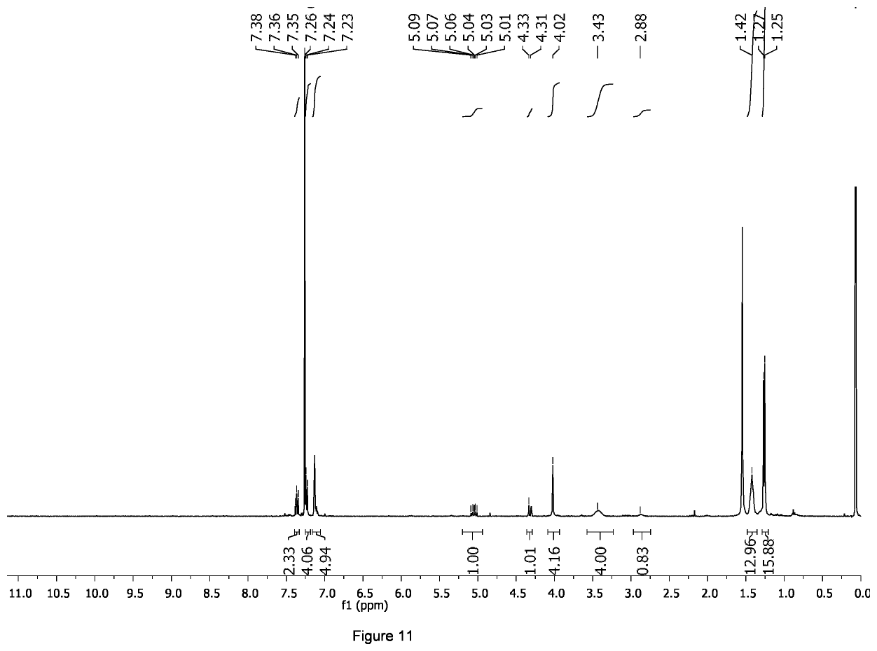

The product was obtained as a microcrystalline powder in 89% yield. The ¹H NMR spectrum is given in FIG. 11.

The analyses of the ¹H NMR spectrum of FIG. 10 and FIG. 11 are given below:

¹H NMR (400 MHz, CDCl₃) δ (ppm) 7.88 (s, H_{NCHN}, 1H), 7.50 (m, p-H_{Ar}, 4H), 7.24 (m, H_{Ar}, 8H), 5.2 (s, H_{cin}, 1H), 4.93 (S, N_{CH—CH}, 4H), 4.51 (d, H_{cin}, 1H), 3.93 (m, CH(iPr), 4H), 3.04 (s, H_{cin}, 1H), 1.41 (m, CH₃)₂, 12H), 1.24 (d, CH₃)₂, 12H) (FIG. 10);

¹H NMR (400 MHz, CDCl₃) δ (ppm) 7.38 (t, p-H_{Ar}, 2H), 7.24 (d, m-H_{Ar}, 4H), 7.1 (s, HPh, 5H), 5.09 (m, H_{cin}, 1H), 4.33 (d, H_{cin}, 1H), 4.02 (S, H_{CH═CH}, 4H), 3.43 (m, CH(iPr), 4H), 2.88 (s, H_{cin}, 1H), 1.42 (m, CH₃)₂, 12H), 1.27 (d, CH₃)₂, 12H) (FIG. 11).

### Example 8: Synthesis of Cu(IPr)Cl Complex

[IPrH][CuCl₂] and K₂CO₃ were ground using ball milling.

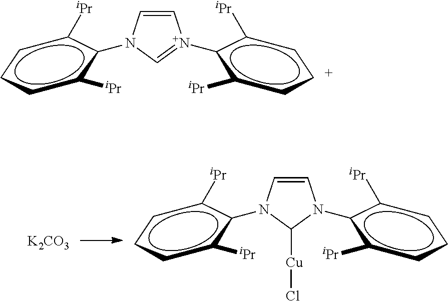

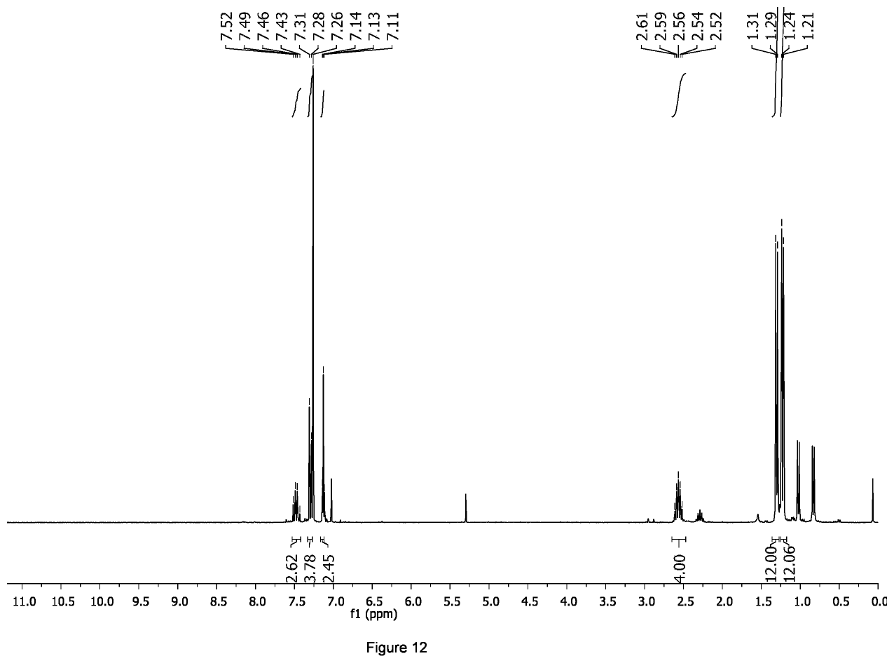

The product was obtained as a powder in 88% (163.2 mg) yield. The ¹H NMR spectrum is given in FIG. 12.

The analysis of the ¹H NMR spectrum of FIG. 12 is given below:

¹H NMR (400 MHz, CDCl₃) δ (ppm) 7.52 (m, H_{CH═CH}, 2H), 7.31 (d, m-H_{Ar}, 4H), 7.14 (t, p-H_{Ar}, 2H), 2.61 (m, CH(iPr), 4H), 1.31 (d, (CH₃)₂, 12H), 1.24 (d, (CH₃)₂, 12H).

### Example 9: Synthesis of Cu(SIMes)Cl Complex

SIMes.HCl and CuCl were ground using ball milling.

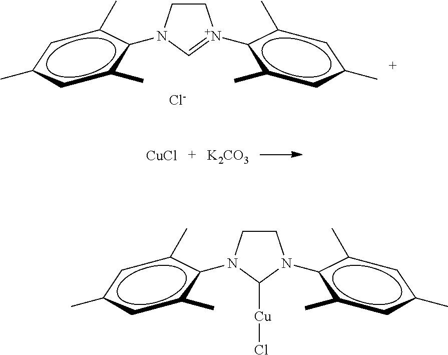

A ¹H NMR spectrum was recorded to confirm formation of the cuprate.

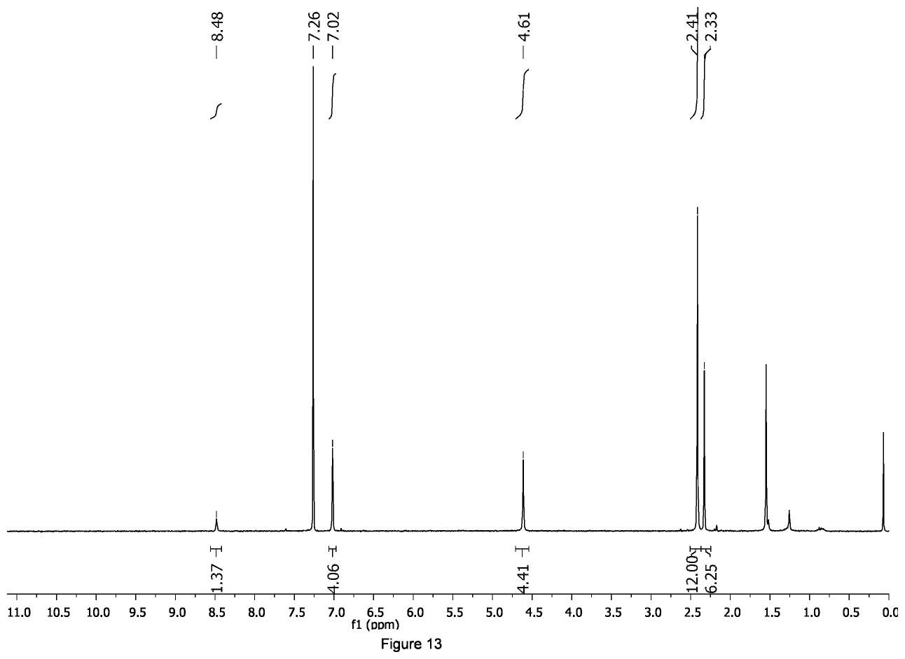

K₂CO₃ was added to the reaction and then ground by ball milling. A ¹H NMR spectrum confirmed product formation (FIG. 13).

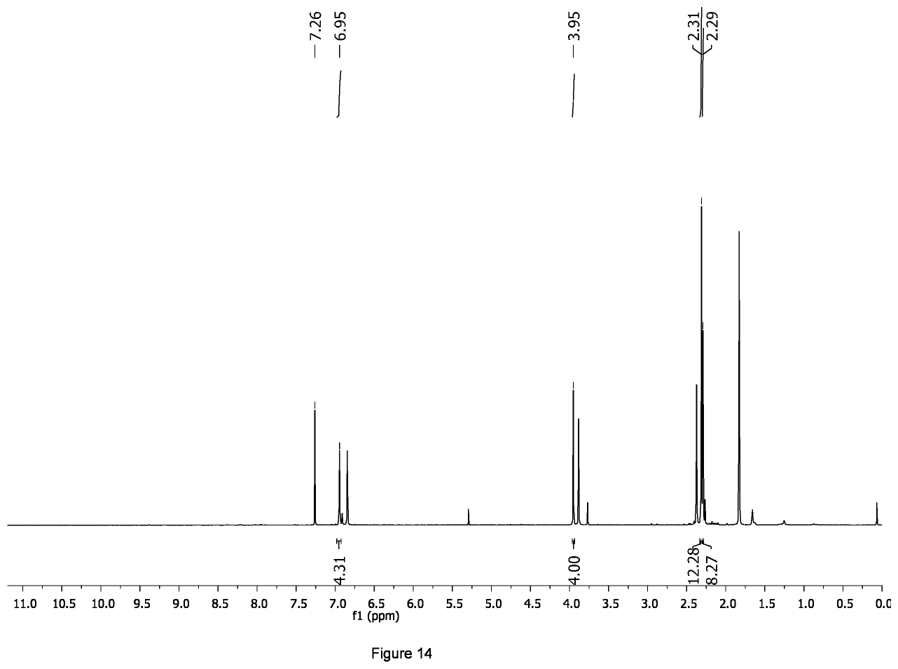

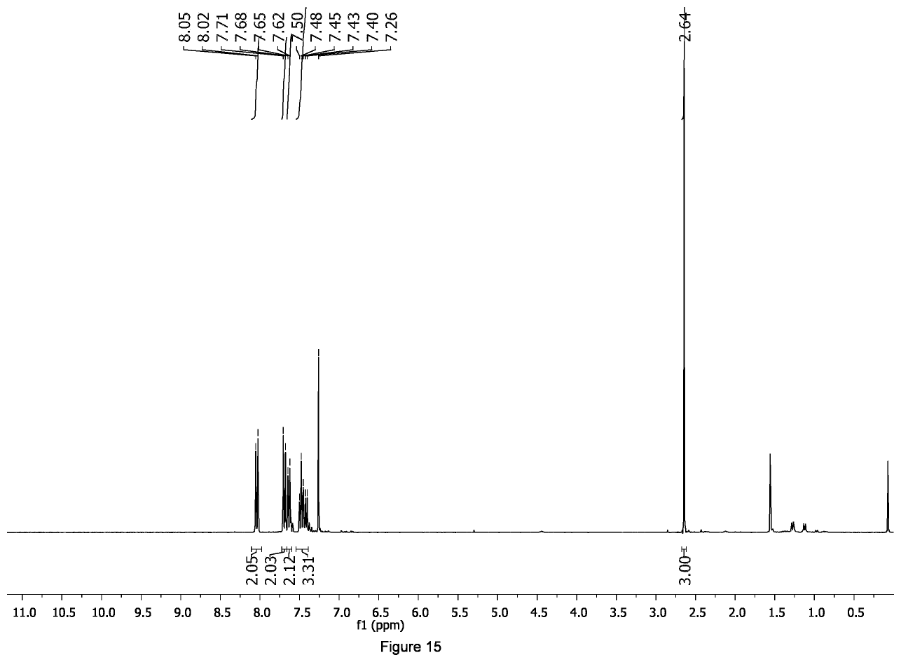

The product was obtained as a microcrystalline powder in 87% yield. The ¹H NMR spectrum is shown in FIG. 14.

The analyses of the ¹H NMR spectra of FIG. 13 and FIG. 14 are given below:

¹H NMR (400 MHz, CDCl₃) δ (ppm) 8.48 (s, H_{NCHN}, 1H), 7.02 (s, H_{Ar}, 4H), 4.61 (s, H_{CH—CH}, 4H), 2.41 (s, o-CH₃, 12H), 2.33 (s, p-CH₃, 6H).

¹H NMR (400 MHz, CDCl₃) δ (ppm) 6.88 (s, H_{Ar}, 4H), 3.89 (s, N_{CH—CH}, 4H), 2.25 (s, o-CH₃, 12H), 2.23 (s, p-CH₃, 6H).

### Example 10: Synthesis of [Pd(IPr)(allyl)Cl]

IPr.HCl and [Pd(allyl)Cl] dimer were ground using ball milling.

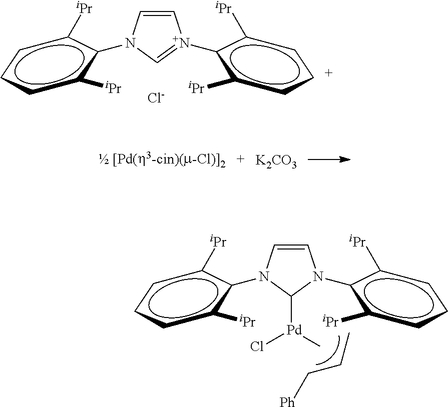

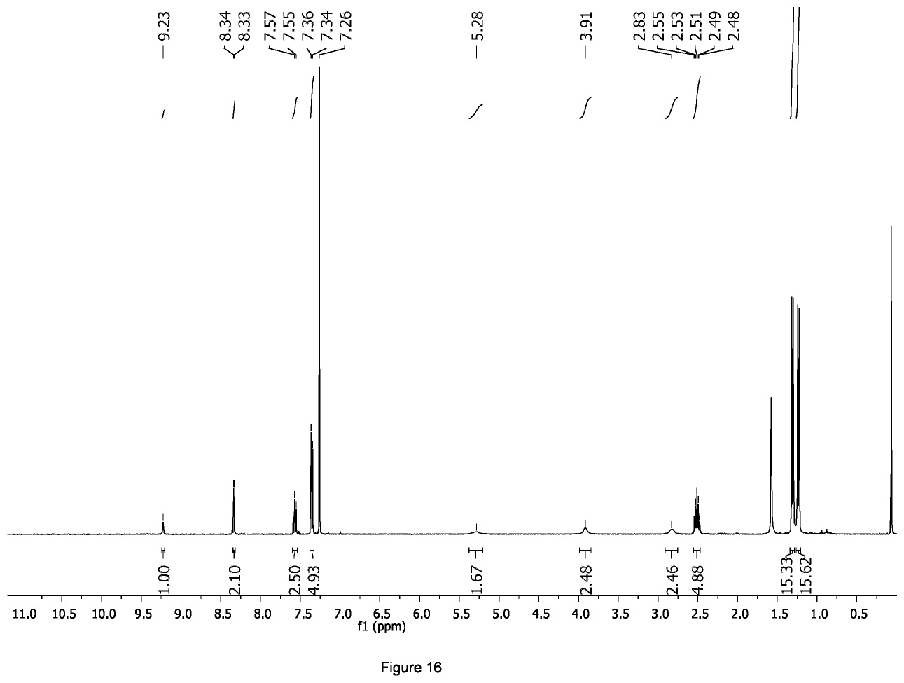

A ¹H NMR spectrum confirmed palladate formation (FIG. 16).

K₂CO₃ was added and then mixed by ball milling.

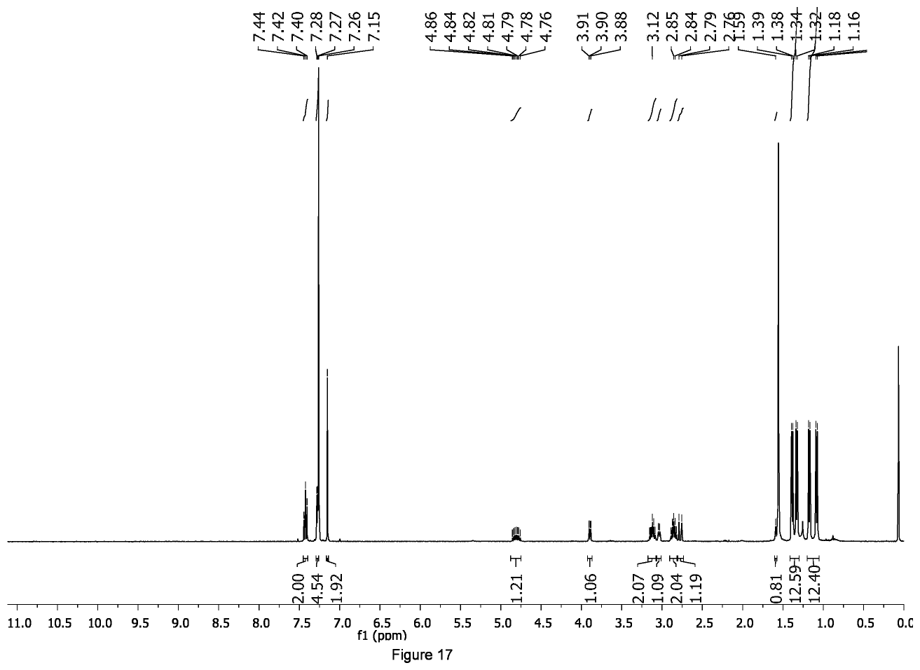

The product was obtained as a microcrystalline powder in 93% yield. The ¹H NMR spectrum is given in FIG. 17.

The analyses of the ¹H NMR spectrum of FIG. 16 and FIG. 17 are given below:

¹H NMR (400 MHz, CDCl₃) δ (ppm) 9.23 (s, H_{NCHN}, 1H), 8.34 (d, H_{CH═CH}, 2H), 7.57 (d, p-H_{Ar}, 2H), 7.36 (d, m-H_{Ar}, 4H), 5.28 (s, H_{allyl}, 1H), 3.91 (s, H_{allyl}, 2H), 2.83 (s, H_{allyl}, 2H), 2.50 (m, CH(iPr), 4H), 1.32 (m, CH₃)₂, 12H), 1.24 (d, CH₃)₂, 12H).

¹H NMR (400 MHz, CDCl₃) δ (ppm) 7.44 (t, p-H_{Ar}, 2H), 7.28 (d, m-H_{Ar}, 4H), 7.15 (s, H_{CH═CH}, 2H), 4.80 (m, H_{allyl}, 1H), 3.90 (dd, H_{allyl}, 1H), 3.15 (m, CH(iPr), 2H), 3.05 (d, H_{allyl}, 1H), 2.87 (m, CH(iPr), 2H), 2.79 (d, H_{allyl}, 1H), 1.59 (s, H_{allyl}, 1H), 1.30 (dd, CH₃)₂, 12H), 1.10 (dd, CH₃)₂, 12H).

### Example 11: Synthesis of [IPr.H][CuCl₂] Metallate

A milling jar was charged with: IPrHCl, CuCl and milling balls. The mixture was ground. The product was obtained in 97% yield. ¹H NMR (400 MHz, CDCl₃) δ (ppm) 1.27 (d, 12H), 1.33 (d, 13H), 2.43 (spt, 4H), 7.40 (d, 4H), 7.60-7.67 (m, 2H), 7.84 (s, 2H), 9.21 (s, 1H).

### Example 12: Synthesis of [Cu(Cl)(IPr)] Complex

A milling jar was charged with: IPrHCl, CuCl and milling balls. The resulting solid mixture was ground and K₂CO₃ was added. The solids were further ground. The product was obtained in 78% yield. ¹H NMR (400 MHz, CDCl₃) δ (ppm) 1.24 (d, 12H) 1.31 (d, 12H), 2.58 (spt, 4H), 7.14 (s, 2H), 7.31 (d, 4H), 7.47-7.53 (m, 2H).

### Example 13: Synthesis of [SIPr.H][CuCl₂] Metallate

A milling jar was charged with: SIPr.HCl, CuCl and milling balls. The mixture was ground. The product was obtained in 96% yield. ¹H NMR (400 MHz, CDCl₃) δ (ppm) 1.28 (d, 12H), 1.44 (d, 12H), 2.97-3.12 (spt, 4H), 4.73 (s, 4H), 7.31 (d, 4H), 7.46-7.55 (m, 2H), 8.15 (s, 1H).

### Example 14: Synthesis of [Cu(Cl)(SIPr)] Complex

A milling jar was charged with: SIPr.HCl, CuCl and milling balls. The resulting solid mixture was ground and K₂CO₃ was added. The solids were further ground. The product was obtained in 66% yield. ¹H NMR (400 MHz, CDCl₃) δ (ppm) 1.36 (d, 12H) 1.38 (d, 12H) 3.08 (spt, 4H) 4.03 (s, 4H) 7.25 (d, 4H) 7.37-7.45 (m, 2H).

### Example 15: Synthesis of [IMes.H][CuCl₂] Metallate

A milling jar was charged with: IMes.HCl, CuCl and milling balls. The mixture was ground. The product was obtained in 98% yield. ¹H NMR (400 MHz, CDCl₃) δ (ppm) 2.18 (s, 12H), 2.39 (s, 6H), 7.10 (s, 4H), 7.64 (s 2H), 9.25 (s, 1H).

### Example 16: Synthesis of [Cu(Cl)(IMes)] Complex

A milling jar was charged with: IMes.HCl, CuCl and milling balls. The resulting solid mixture was ground and K₂CO₃ was added. The solids were further ground. The product was obtained in 65% yield. ¹H NMR (400 MHz, CDCl₃) δ (ppm) 2.11 (s, 12H) 2.36 (s, 6H) 7.01 (s, 4H) 7.06 (s, 2H).

### Example 17: Synthesis of [SIMes.H][CuCl₂] Metallate

A milling jar was charged with: SIMes.HCl, CuCl and milling balls. The mixture was ground. The product was obtained in 92% yield. ¹H NMR (400 MHz, CDCl₃) δ (ppm) 2.32 (s, 6H), 2.40 (s, 12H), 4.59 (br s, 4H), 7.01 (s, 4H), 8.36 (s, 1H).

### Example 18: Synthesis of [Cu(Cl)(SIMes)] Complex

A milling jar was charged with: SIMes.HCl, CuCl and milling balls. The resulting solid mixture was ground and K₂CO₃ was added. The solids were further ground. The product was obtained in 65% yield. ¹H NMR (400 MHz, CDCl₃) δ (ppm) 2.31 (s, 6H) 2.32-2.34 (m, 1H) 2.32 (s, 11H) 3.96 (s, 4H) 6.96 (s, 4H).

### Example 19: Synthesis of [Cu(Cl)(IPr*)] Complex

A milling jar was charged with: IPr*HCl, CuCl and milling balls. The resulting solid mixture was ground and K₂CO₃ was added. The solids were further ground. The product was obtained in 72% yield.

### Example 20: Synthesis of [Cu(Cl)(ItBu)] Complex

A milling jar was charged with: ItBu.HCl, CuCl and milling balls. The resulting solid mixture was ground and K₂CO₃ was added. The solids were further ground. The product was obtained in 48% yield. ¹H NMR (400 MHz, CDCl₃) δ (ppm) 1.79 (s, 18H), 7.05 (s, 2H).

### Example 21: Synthesis of [Ag(Cl)(IPr)] Complex

A milling jar was charged with: IPrHCl, AgCl and milling balls. The resulting solid mixture was ground and K₂CO₃ was added. The solids were further ground. The product was obtained in 70% yield. ¹H NMR (400 MHz, CDCl₃) δ (ppm) 1.23 (d, 12H) 1.29 (d, 12H) 2.55 (spt, 4H) 7.22 (d, 2H) 7.31 (d, 4H) 7.48-7.54 (m, 12H).

### Example 22: Synthesis of [Ag(Cl)(SIPr)] Complex

A milling jar was charged with: SIPr.HCl, AgCl and milling balls. The resulting solid mixture was ground and K₂CO₃ was added. The solids were further ground. The product was obtained in 70% yield. ¹H NMR (400 MHz, CDCl₃) δ (ppm) 1.35 (d, 12H) 1.37 (d, 12H) 3.07 (spt, 4H) 4.08 (s, 4H) 7.24-7.29 (m, 4H) 7.39-7.45 (m, 2H).

### Example 23: Synthesis of [Ag(Cl)(IPr*)] Complex

A milling jar was charged with: IPr*HCl, AgCl and milling balls. The resulting solid mixture was ground and K₂CO₃ was added. The solids were further ground. The product was obtained in 64% yield.

### Example 24: Synthesis of [Ag(Cl)(ICy)] Complex

A milling jar was charged with: ICy.HCl, AgCl and milling balls. The resulting solid mixture was ground and K₂CO₃ was added. The solids were further ground. The product was obtained in 17% yield.

### Example 25: Synthesis of [Rh(cod)(Cl)(IMes)] Metallate

A milling jar was charged with: IMes.HCl, [Rh(cod)(μ-Cl)]2, K₂CO₃ and milling balls. The mixture was ground. The product was obtained in 74% yield. ¹H NMR (400 MHz, CDCl₃) δ (ppm) 1.56 (br d, 4H) 1.71-1.94 (m, 4H) 2.12 (s, 6H) 2.40 (s, 64H) 2.41 (s, 6H) 3.31 (br d, 2H) 4.54 (br s, 2H) 6.96 (s, 2H) 7.02 (br s, 2H) 7.07 (br s, 2H).

### Example 26: Synthesis of [Ir(cod)(Cl)(IMes)] Complex

A milling jar was charged with: IMes.HCl, [Rh(cod)(μ-Cl)]₂, K₂CO₃ and milling balls. The mixture was ground. The product was obtained in 94% yield. ¹H NMR (400 MHz, CDCl₃) δ (ppm) 1.17-1.39 (m, 4H) 1.52-1.80 (m, 4H) 2.17 (m, 6H) 2.36 (s, 6H) 2.37 (br s, 6H) 2.95-2.99 (m, 2H) 4.11-4.19 (m, 2H) 6.96 (br s, 2H) 6.98 (br s, 2H) 7.01 (br s, 2H).

### Example 27: Synthesis of [Ag(Cl)(IAd)] Complex

A milling jar was charged with: IAd.HCl, AgCl and milling balls. The resulting solid mixture was ground and K₂₀₀₃ was added. The solids were further ground. The product was obtained in 48% yield.

### Example 28: Synthesis of [Cu(Cl)(IAd)] Complex

A milling jar was charged with: IAd.HCl, CuCl and milling balls. To the resulting solid mixture K₂CO₃ was added. The solid mixture was further ground. The product was obtained in 20% yield.

### Example 29: Synthesis of [Cu(Cl)(MIC A)] Complex

A milling jar was charged with: MIC A.HCl, CuCl and milling balls. The resulting solid mixture was ground and K₂CO₃ was added. The solids were further ground. The product with the following structure was obtained in 58% yield:

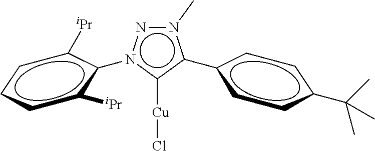

### Example 30: Synthesis of [Cu(Cl)(CAAC^{Me2})] Complex

A milling jar was charged with: CAAC^{Me2}.HCl, CuCl and milling balls. The resulting solid mixture was ground and K₂CO₃ was added. The solids were further ground. The product with the following structure was obtained in 23% yield:

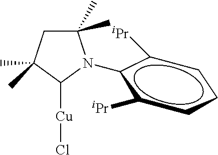

### Example 31: Synthesis of [Cu(Cl)(CAAC^{Cy})] Complex

A milling jar was charged with: CAAC^{Cy}.HCl, CuCl and milling balls. The resulting solid mixture was ground and K₂CO₃ was added. The solids were further ground. The product with the following structure was obtained in 26% yield:

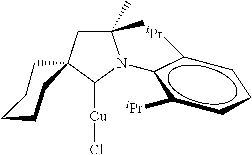

### Example 32: Synthesis of [Rh(cod)(Cl)(CAAC^{Cy})] Complex

A milling jar was charged with: CAAC^{Cy}.HCl (100 mg), [Rh(cod)(μ-Cl)]2, K₂CO₃ and milling balls. The mixture was ground. The product with the following structure was obtained in 19% yield:

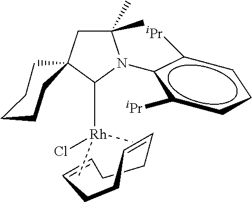

### Example 33: Synthesis of [Rh(cod)(Cl)(CAAC^{Me2})] Complex

A milling jar was charged with: CAAC^{Me2}.HCl (100 mg), [Rh(cod)(μ-Cl)]2, K₂CO₃ and milling balls. The mixture was ground. The product with the following structure was obtained in 22% yield:

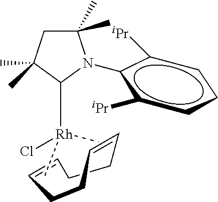

### Example 34: Catalysis: Suzuki-Miyaura Cross-Coupling: Synthesis of 4-Acetylbiphenyl

K₂CO₃ (207.3 mg, 1.5 mmol, 1.5 equiv.) and [Pd(IPr)(Cin)Cl] (12.9 mg, 0.02 mmol, 0.02 equiv.) were ground together by ball milling. Phenylboronic acid (199 mg, 1 mmol, 1 equiv.) and 4-bromoacetophenone (146.3 mg, 1.2 mmol, 1.2 equiv.) were added to the reaction mixture that was ground for 10 minutes.

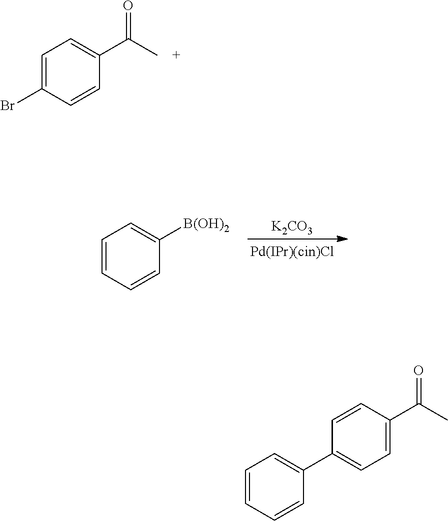

A ¹H NMR spectrum was recorded in order to confirm product formation. To obtain 4-acetylbiphenyl two additional 10-minute cycles were required.

Using a flask (250 mL), the powder content from the lid, the reactor bowl and from the balls was transferred using dichloromethane (approximately 25 mL). After filtration through Celite and washing of the Celite pad with 15 mL of dichloromethane, the dichloromethane solution was washed with brine (2×20 mL) and the organic phase was separated and dried over MgSO₄. The solution was filtered through a paper filter and the volatiles were removed using a rotary evaporator then the solids placed under vacuum using a Schlenk vacuum line to remove any residual solvent overnight.

The product was obtained as powder in an 86% (168.6 mg) yield. The ¹H NMR spectrum is given in FIG. 17.

The analysis of the ¹H NMR spectrum of FIG. 17 is given below:

¹H NMR (400 MHz, CDCl₃) δ (ppm) 8.05 (d, H_{Ar}, 2H), 7.7 (d, H_{Ar}, 2H), 7.49 (m, H_{Ar}, 2H), 2.64 (s, CH₃, 3H).

Test results showed that synthesis of the catalyst and the use of the catalyst can be carried out in the same reactor using the same conditions. This means that the method according to the present invention allows to perform three steps without purification:
1) The metallate formation;
2) The carbene-metal complex formation, in particular nitrogen-containing heterocyclic carbene-metal complex formation; and
3) The use of the NHC-complex in a catalytic reaction.

Steps 1 and step 2 can be performed either in two steps or in a single step.

1. A method of preparing a metal complex of formula Z-M, the method comprising the steps of
i1) providing a salt of formula Z⁺—X⁻ and a non-ionic metal salt of formula MLₙ; or
i2) providing a metallate of formula Z⁺. . . MLₙX⁻,
with
Z comprising a two-electron donor ligand;
X comprising an anion;
M comprising a metal;
L comprising an anion or an electron donor ligand;
and
ii) subjecting the salt of formula Z⁺—X⁻ and the metal salt of formula ML of step i1) or the metallate of formula Z⁺. . . MLₙX⁻, of step i2) to a mechanical mixing process in the presence of a base to form said metal complex of formula Z-M.

2. The method according to claim 1, wherein said method does not require the use of a solvent.

3. The method according to claim 1, wherein said salt of formula Z⁺—X⁻ of step i1) has a single two-electron donor ligand Z or wherein said metallate of formula Z⁺. . . MLₙX⁻ of step i2) has a single two-electron donor ligand Z.

4. The method according to claim 1, wherein said non-ionic metal salt of formula ML comprises a single metal M.

5. The method according to claim 1, wherein said metal complex of formula Z-M has a single two-electron donor ligand Z.

6. The method according to claim 1, wherein Z comprises a carbene, a phosphorus donor ligand, a nitrogen donor ligand or any other heteroatom donor ligand.

7. The method according to claim 1, wherein said metal complex of formula Z-M comprises a carbene-metal complex.

8. The method according to claim 7, wherein the nitrogen-containing heterocyclic carbene ligand is in the form of 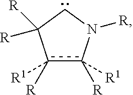
wherein each of the groups R may be the same or different, the groups R¹ where present may be the same or different and the dashed line in the ring represents optional unsaturation, when R¹ and R² are absent;
wherein each R and R¹ is independently for each occurrence selected from: hydrogen, a primary, secondary or tertiary alkyl group that may be unsaturated and may be substituted or unsubstituted and may be cyclic, substituted or unsubstituted aryl, a substituted or unsubstituted heterocycle, or a functional group selected from the group consisting of halide, hydroxyl, alkoxyl, aryloxyl, sulfhydryl, cyano, cyanate, thicyanato, amino, nitro, nitroso, sulfo, sulfonato, boryl, borono, phosphono, phosphonato, phosphinato, phospho, phosphino and silxy; and
wherein one or more of the carbon atoms in the ring apart from the carbene carbon may be substituted with B, O, P or S.

9. The method according to claim 7, wherein the nitrogen-containing heterocyclic carbene ligand is of the form 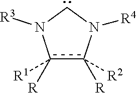
wherein each of the groups R, R¹, R², R³ and R⁴ may be the same or different and the dashed line in the ring represents optional unsaturation, when R1 and R2 are absent; and
wherein R and R¹, R², R³ and R⁴ are independently for each occurrence selected from:
hydrogen, a primary, secondary or tertiary alkyl group that may be unsaturated and may be substituted or unsubstituted and may be cyclic, substituted or unsubstituted aryl, a substituted or unsubstituted heterocycle, or a functional group selected from the group consisting of halide, hydroxyl, alkoxyl, aryloxyl, sulfhydryl, cyano, cyanate, thicyanato, amino, nitro, nitroso, sulfo, sulfonate, boryl, borono, phosphona, phosphonato, phosphinato, phospho, phosphino and siloxy.

10. The method according to claim 7, wherein the nitrogen-containing heterocyclic ligand Z is selected from the group consisting of

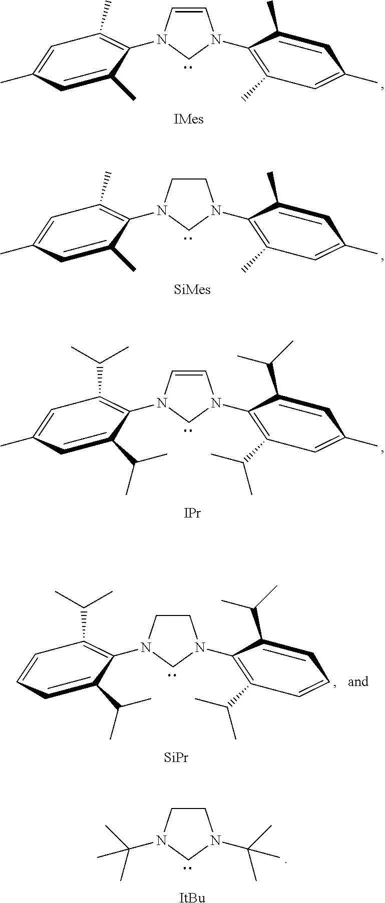

11. The method according to claim 1, wherein X is selected from the group consisting of halides, carboxylates, alkoxy groups, aryloxy groups, alkylsulfonates, acetates, trifluoroacetates, tetrafluoroborates, hexafluorophosphates, hexafluoroantimonates, cyanides, thiocyanates, isothiocyanates, cyanates, isocyanates, azides and selenocyanates.

12. The method according to claim 1, wherein M comprises a transition metal and/or wherein L is selected from the group consisting of fluoride (F⁻), chloride (Cl⁻), bromide (Br⁻), iodide (I⁻), triflate (trifluoromethane sulfonate) (OTf⁻), acetate (OAc⁻), trifluoroacetate (TFA⁻), tetrafluoroborate (BF₄⁻), hexafluorophosphate (PF₆⁻), hexafluoroantimonate (SbF₆⁻), sulfate (SO₄²⁻) and phosphate (PO₃²⁻).

13. The method according to claim 1, wherein said mechanical mixing process comprises ball milling, hand grinding, twin-screw extrusion or a combination thereof.

14. The method according to claim 1, wherein said base is selected from the group consisting of carbonates, hydrogen carbonates, phosphates and amines.

15. The method according to claim 1, wherein said metallate of step i2) is obtainable from mixing a salt of formula Z⁺—X⁻ with a metal salt of formula ML while subjecting to a mechanical mixing process.

16. A carbene metal complex obtainable from the method of claim 1 and suitable for use as a catalyst.

17. The method according to claim 7, wherein said carbene-metal complex comprises a nitrogen-containing heterocyclic carbene (NHC) ligand.
